(19) United States
(12) Patent Application Publication
(10) Pub. No.: US 2025/0105763 A1
(43) Pub. Date: Mar. 27, 2025

(54) ENERGY HARVESTER, METHOD, AND SYSTEM

(71) Applicant: Baker Hughes Oilfield Operations LLC, Houston, TX (US)

(72) Inventors: Christopher Hern, Porter, TX (US); Daniel C. Ewing, Katy, TX (US); Andrew Duggan, Meadows Place, TX (US); Ronnie Russell, Cypress, TX (US); Kamalesh Chatterjee, Tomball, TX (US); Carl Stoesz, Blacksburg, VA (US)

(21) Appl. No.: 18/476,048

(22) Filed: Sep. 27, 2023

(51) Int. Cl. H02N 2/18; E21B 41/00

(52) U.S. Cl. CPC H02N 2/183; E21B 41/0085; H02N 2/185

(57) ABSTRACT

An energy harvester, including a cyclical impulse device, and a piezoelectric generator deformably connected to the device. A method for harvesting energy from a flowing fluid including inducing a selected flow regime, causing a cyclical impulse device to cycle based upon the flow regime, and physically deforming a piezoelectric generator with the device. A wellbore system, including a borehole in a subsurface formation, a string in the borehole, and an energy harvester disposed within or as a part of the string.

### BACKGROUND

In the resource recovery and fluid sequestration industries, instrumented structures in the downhole environment continually become more prevalent. This comes with increasing demand for power. While conduits for power can be run, they occupy space that is already at a premium. Batteries can eliminate the conduits but have limited lifetimes. Alternate sources of power would be welcomed by the art.

### SUMMARY

An embodiment of an energy harvester, including a cyclical impulse device, and a piezoelectric generator deformably connected to the device.

An embodiment of a method for harvesting energy from a flowing fluid including inducing a selected flow regime, causing a cyclical impulse device to cycle based upon the flow regime, and physically deforming a piezoelectric generator with the device.

An embodiment of a wellbore system, including a borehole in a subsurface formation, a string in the borehole, and an energy harvester disposed within or as a part of the string.

### BRIEF DESCRIPTION OF THE DRAWINGS

The following descriptions should not be considered limiting in any way. With reference to the accompanying drawings, like elements are numbered alike:

FIG. 1 is a sectional perspective view illustrating a number of energy harvesters as disclosed herein;

FIG. 2 is a sectional view of a harvester in a run in position;

FIG. 3 is a sectional view of the harvester in a choking flow position;

FIG. 4 is a sectional view of the harvester in a shifting position;

FIG. 5 is a sectional view of the harvester just before unseat;

FIG. 6 is a sectional view of the harvester in a choke reset position;

FIG. 7 is a sectional view of the harvester in a fully reset position with generator impact and is identical to the run in position illustrated in FIG. 2;

FIG. 8 is another embodiment of the harvester disclosed herein; and

FIG. 9 is a view of a borehole system including an energy harvester as disclosed herein.

### DETAILED DESCRIPTION

A detailed description of one or more embodiments of the disclosed apparatus and method are presented herein by way of exemplification and not limitation with reference to the Figures.

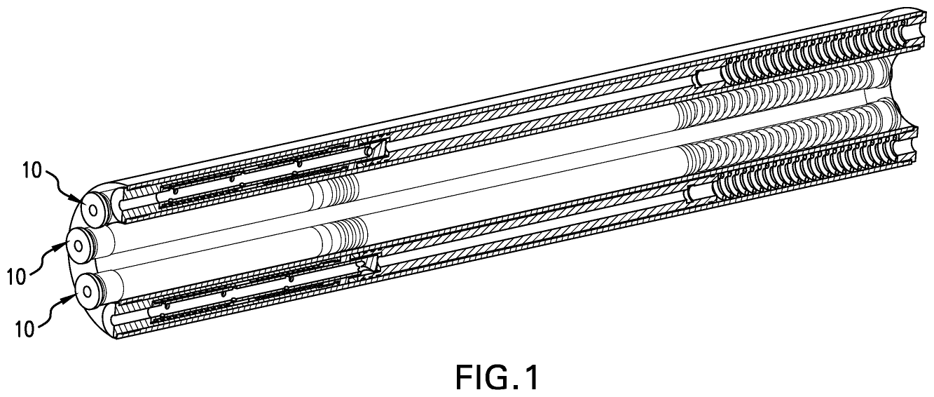

Referring to FIG. 1, an energy harvester 10 is illustrated. In fact, three harvesters 10 are illustrated and two sectioned harvesters 10 are illustrated in FIG. 1 annularly arranged about the Figure. In the FIG. 1 embodiment, eight total harvesters 10 are disposed about a tubular member. More or fewer are contemplated. The harvester 10 comprises a cyclical impulse device 12 and a piezoelectric generator 14 (particular embodiments being generator 34 and generator 36 disclosed herein) deformably connected to the device 12. “Deformably” as used herein should be understood to mean any deformation of the geometric shape of the generator, whether that deformation be due to bending, torsion, impact, etc., that does not result in plastic deformation but rather remains in the elastic regime.

In an embodiment, the cyclical impulse device 12 comprises a housing 16, within which is disposed a choke housing 18, a weighted sleeve 20, and a sleeve biaser 22. Within the choke housing 18 is disposed a choke 24 and two choke biasers 26 and 28. The choke 24 also includes a flow deviation path 30 to cause Bernoulli related reduced pressure in flow at an intersection 32 between the choke 24 and the weighted sleeve 20. Also illustrated is an impact based generator 34. It is to be understood that a generator 36 may also be positioned as a part of the biaser 22 at any point along the biaser 22 or the biaser 22 may be constructed from piezoelectric material and hence actually be a generator itself. The same is true to biasers 26 and 28, i.e., either or both may include a generator or be a generator. This would be a generator that generates a voltage potential through bending or torsion of the generator 36.

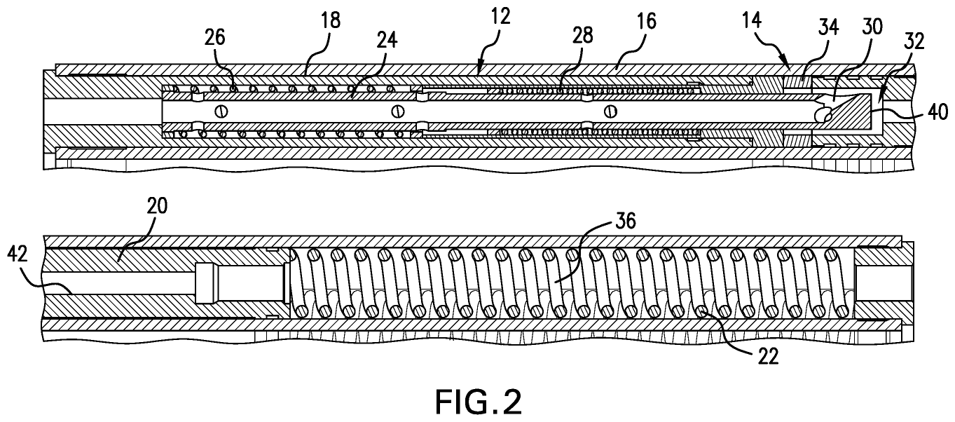

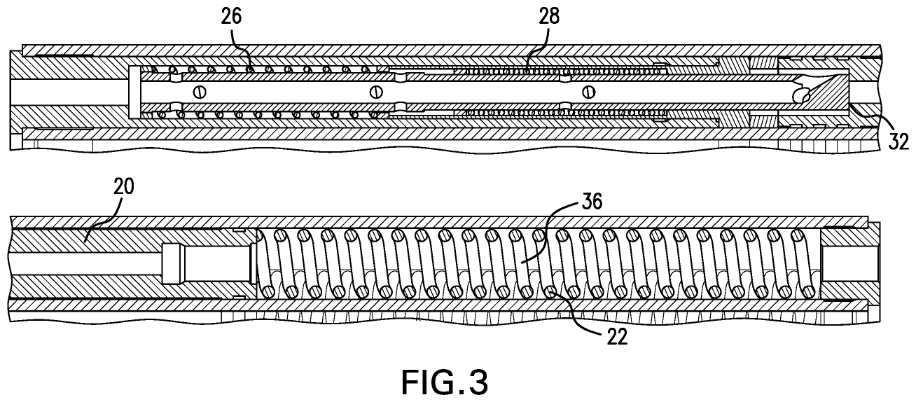

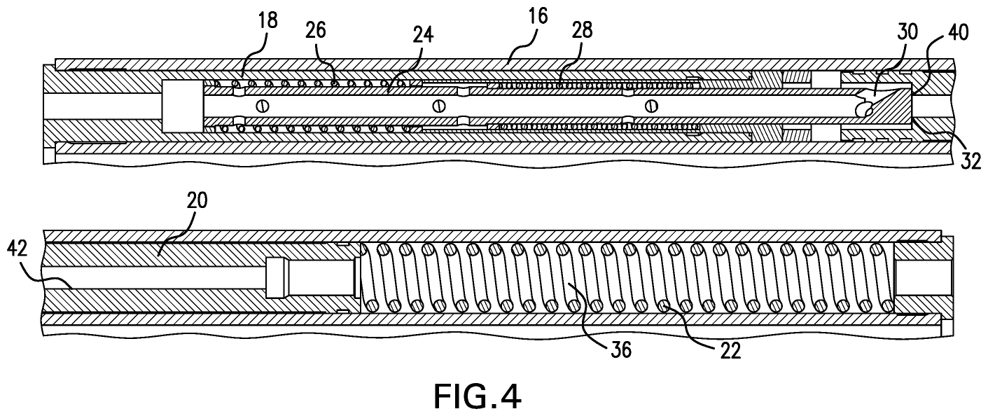

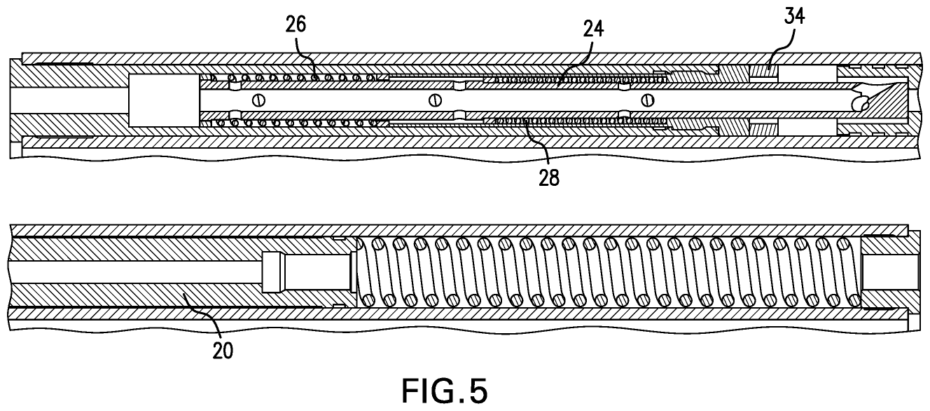

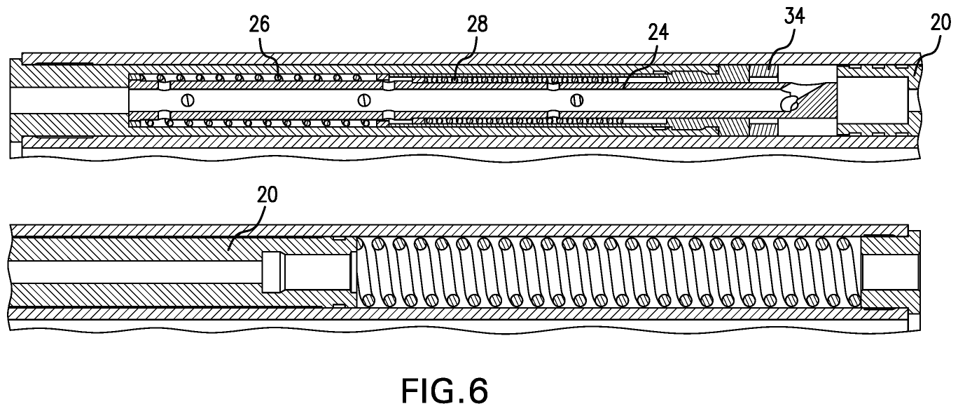

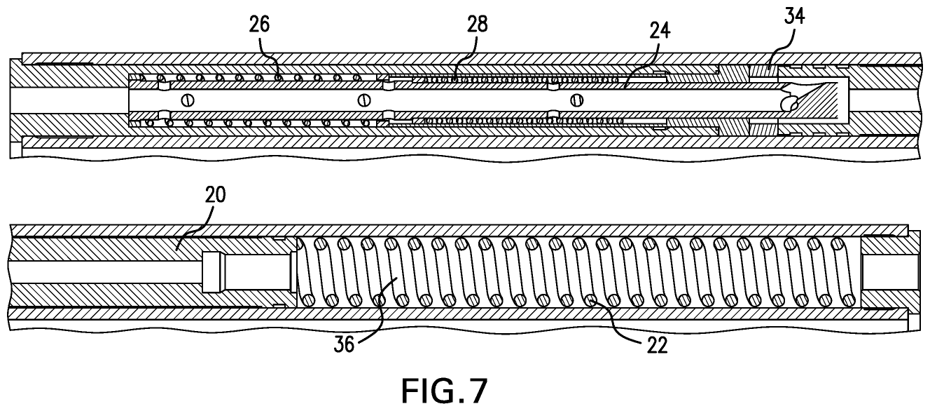

In operation, referring to FIG. 2-7, which form a sequence, the device 12 starts in the position of FIG. 2. Flow is commenced through the choke 24 whereby that flow is deflected at the flow deviation path 30 so that it flows around a tip 40 of the choke 24 and into a bore 42 of the weighted sleeve 20. The circuitous route of the flow causes a local pressure drop in that flow and hence causes the choke 24 to be brought into contact with the weighted sleeve 20 (FIG. 3). Once contact is made between the choke 24 and the weighted sleeve 20, flow through the device 12 substantially stops and instead flow upstream of the device 12 contributes to an increasing hydraulic pressure against the choke 24 and the weighted sleeve 20. The pressure results in the biaser 22 being compressed, the biaser 26 being compressed and the biaser 28 being compressed (in various stages, see FIGS. 4-5 for relative movement) based upon the relative closeness of the choke 24 to the sleeve 20 and then the hydraulic pressure brought to bear on the device 12. At a threshold, the biasers 26 and 28 have more potential energy than the hydraulic pressure applies (FIG. 6) and they urge the choke 24 out of contact with the sleeve 20. Due to differing inertia of the choke 24 and the sleeve 20, the choke 24 responds much more quickly and returns to its initial position (shown in FIG. 6). The sleeve 20, which has a higher inertial mass than the choke 24 returns to the initial position more slowly but does so with a significant amount of force. That force is transferred to generator 34 through impact (see FIG. 7) and a large voltage potential is realized. It will be appreciated that the cycle of the device 12 as illustrated beginning with FIG. 2 ends with FIG. 7, which is identical to FIG. 2. The device 12 is then in position to begin the cycle again. The actions discussed will be cyclical as long as flow is available. Accordingly, the device 12 will continue to bang the generator 34 in a regular interval or deform the generator(s) 36 or both for as long as flow is provided to the device 12. The harvester 10 then will continue to generate power that is usable for a plethora of needs.

A device similar to device 12 disclosed herein is commercially available under the tradename Rat Pack from Baker Hughes, Houston, Texas, but that device does not generate power. It merely is used to vibrate stuck tools loose. The inventors hereof have determined that the cyclical nature of the device 12 may be used for another purpose to support power hungry modern well systems. Specifically, because the device 12 includes components that will move back and forth essentially indefinitely while fluid is flowing, that motion can be used to generate voltage potential by coupling the piezo electric generator 34, 36 or both to the moving components of device 12 in such a way as that the generator 34, 36 or both experiences strain to thereby produce the voltage potential. The greater the strain and the greater the rate of change in that strain, the greater the voltage potential. Accordingly, the impact function generates a large voltage potential.

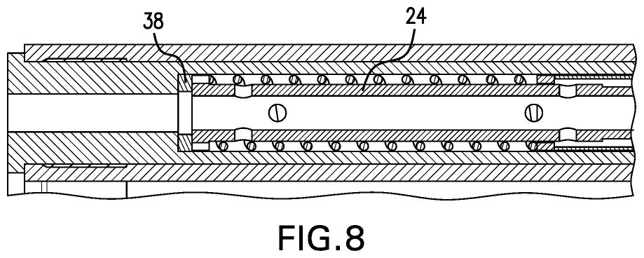

In another embodiment hereof, referring to FIG. 8, there may be a generator 38 that is positioned to interact with the choke 24. This generator may be used on its own, or may be combined with generator 34 and or 36. Generator 38 operates in the same way as generator 34 by impact but does so with the choke 24 rather than the weighted sleeve 20. As the choke resets from FIG. 5 to FIG. 6, the generator 38 is impacted thereby generating a large voltage potential.

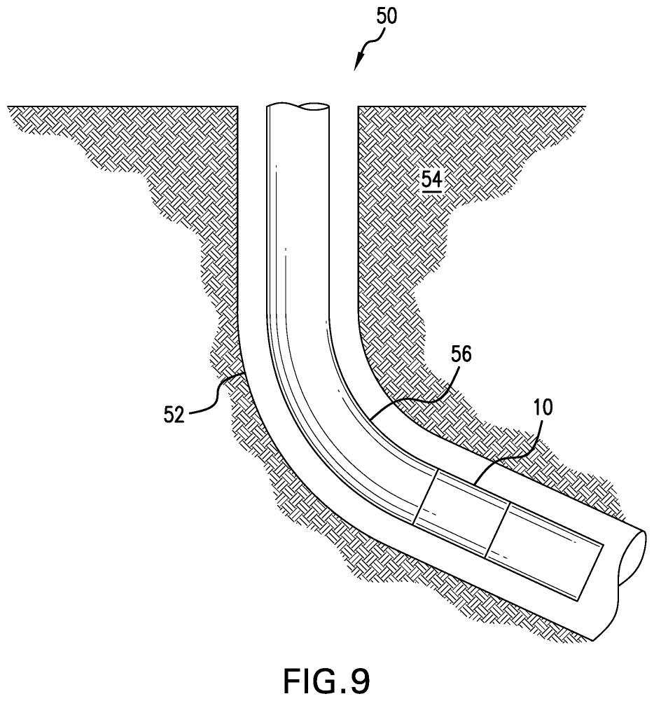

Referring to FIG. 9, a borehole system 50 is illustrated. The system 50 comprises a borehole 52 in a subsurface formation 54. A string 56 is disposed within the borehole 52. An energy harvester 10 as disclosed herein is disposed within or as a part of the string 56.

Set forth below are some embodiments of the foregoing disclosure:

Embodiment 1: An energy harvester, including a cyclical impulse device, and a piezoelectric generator deformably connected to the device.

Embodiment 2: The harvester as in any prior embodiment, wherein the device includes a biaser.

Embodiment 3: The harvester as in any prior embodiment, wherein the biaser is a coil spring.

Embodiment 4: The harvester as in any prior embodiment, wherein the device includes a plurality of biasers.

Embodiment 5: The harvester as in any prior embodiment, wherein the generator is positioned to be impacted by a portion of the device.

Embodiment 6: The harvester as in any prior embodiment, wherein the portion of the device is one or both of a weighted sleeve or a choke.

Embodiment 7: The harvester as in any prior embodiment, wherein the generator is a part of the device.

Embodiment 8: The harvester as in any prior embodiment, wherein the generator is embedded in a coil spring of the device.

Embodiment 9: The harvester as in any prior embodiment, wherein the generator is a plurality of generators.

Embodiment 10: A method for harvesting energy from a flowing fluid including inducing a selected flow regime, causing a cyclical impulse device to cycle based upon the flow regime, and physically deforming a piezoelectric generator with the device.

Embodiment 11: The method as in any prior embodiment, wherein the causing includes building pressure on the device to store potential energy therein.

Embodiment 12: The method as in any prior embodiment, wherein the causing includes releasing the potential energy in the device.

Embodiment 13: The method as in any prior embodiment, wherein the changing is automatic based upon the fluid flow regime.

Embodiment 14: The method as in any prior embodiment, wherein the deforming is through bending below plastic deformation.

Embodiment 15: The method as in any prior embodiment, wherein the deforming is through impact loading below plastic deformation.

Embodiment 16: The method as in any prior embodiment, wherein the deforming includes generating a voltage potential in the generator.

Embodiment 17: A wellbore system, including a borehole in a subsurface formation, a string in the borehole, and an energy harvester as in any prior embodiment disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. An energy harvester, comprising:
a cyclical impulse device; and
a piezoelectric generator deformably connected to the device.

2. The harvester as claimed in claim 1, wherein the device includes a biaser.

3. The harvester as claimed in claim 2, wherein the biaser is a coil spring.

4. The harvester as claimed in claim 1, wherein the device includes a plurality of biasers.

5. The harvester as claimed in claim 1, wherein the generator is positioned to be impacted by a portion of the device.

6. The harvester as claimed in claim 5, wherein the portion of the device is one or both of a weighted sleeve or a choke.

7. The harvester as claimed in claim 1, wherein the generator is a part of the device.

8. The harvester as claimed in claim 1, wherein the generator is embedded in a coil spring of the device.

9. The harvester as claimed in claim 1, wherein the generator is a plurality of generators.

10. A method for harvesting energy from a flowing fluid comprising:
inducing a selected flow regime;
causing a cyclical impulse device to cycle based upon the flow regime; and
physically deforming a piezoelectric generator with the device.

11. The method as claimed in claim 10, wherein the causing includes building pressure on the device to store potential energy therein.

12. The method as claimed in claim 10, wherein the causing includes releasing the potential energy in the device.

13. The method as claimed in claim 10, wherein the changing is automatic based upon the fluid flow regime.

14. The method as claimed in claim 10, wherein the deforming is through bending below plastic deformation.

15. The method as claimed in claim 10, wherein the deforming is through impact loading below plastic deformation.

16. The method as claimed in claim 10, wherein the deforming includes generating a voltage potential in the generator.

17. A wellbore system, comprising:
a borehole in a subsurface formation;
a string in the borehole; and
an energy harvester as claimed in claim 1 disposed within or as a part of the string.
